(19) United States
(12) Patent Application Publication
(10) Pub. No.: US 2022/0173906 A1
(43) Pub. Date: Jun. 2, 2022

(54) METHOD AND CONTROL SYSTEM FOR CONTROLLING AN EXECUTION OF TRANSACTIONS

(71) Applicant: Siemens Aktiengesellschaft, München (DE)

(72) Inventors: Hans Aschauer, München (DE); Andreas Bogner, München (DE); Ingo Wenda, Augsbur (DE); Markus Dichtl, Neu-Ulm (DE)

(21) Appl. No.: 17/441,322

(22) PCT Filed: Feb. 25, 2020
(86) PCT No.: PCT/EP2020/054929

§ 371 Date: Sep. 21, 2021

(30) Foreign Application Priority Data
Mar. 27, 2019 (EP) 19165406.0

(51) Int. Cl. H04L 9/32; G06F 21/64; G06F 9/46

(52) U.S. Cl. CPC H04L 9/3239; H04L 9/3247; H04L 2209/38; G06F 9/467; G06F 21/64

(57) ABSTRACT

Provided is a control system, with which, for example, the execution of smart contracts in blockchains can be improved.

### CROSS-REFERENCE TO RELATED APPLICATIONS

This application claims priority to PCT Application No. PCT/EP2020/054929, having a filing date of Feb. 25, 2020, which claims priority to EP Application No. 19165406.0, having a filing date of Mar. 27, 2019, the entire contents both of which are hereby incorporated by reference.

### FIELD OF TECHNOLOGY

The following relates to a method and a control system for controlling an execution of transactions.

### SUMMARY

An aspect relates to a control system having:
a memory module, wherein
the memory module is configured to store at least one transaction (e.g., can also be referred to as a useful transaction) and/or at least one execution control transaction and/or at least one presupposition transaction;
an assigning module, wherein
the assigning module is configured to assign the execution control transaction and/or the presupposition transaction to the transaction,
the execution control transaction controls an execution of the transaction by the control system when presuppositions of the presupposition transaction are complied with.

The control system can for example be realized by a network application and/or a distributed database system and/or a blockchain. The control system can for example also be a network application or a distributed database system or a blockchain or can be implemented as such. By way of example, the memory module and/or the assigning module can be realized by a network application and/or a distributed database system and/or a blockchain. By way of example, a network application and/or a distributed database system and/or a blockchain can comprise the memory module and/or the assigning module.

The technology of blockchains or “distributed ledgers” is currently a hotly discussed technology that can, in particular, be implemented as a distributed database system or as a network application. Besides applications for local payment systems (e.g., Bitcoin), new application possibilities are being developed in the finance industry. In particular, transactions between firms can therefore be performed in a manner protected against manipulation without a mediator or clearing house. This allows new business models without a trusted mediator and reduces transaction costs, and new digital services can be provided flexibly without having to establish an infrastructure set up specifically for the digital services and relationships of trust. A transaction data record (or transaction, for short) protected by a blockchain comprises e.g., program code, which can also be referred to as what is known as a “smart contract”.

Unless indicated otherwise in the description below, the terms “perform”, “calculate”, “computer-aided”, “compute”, “discover”, “generate”, “configure”, “reconstruct” and the like relate to actions and/or processes and/or processing steps that alter and/or produce data and/or that convert data into other data, the data being able to be presented or available as physical variables, in particular, for example as electrical impulses. In particular, the expression “computer” should be interpreted as broadly as possible in order to cover in particular all electronic devices having data processing properties. Computers can therefore be for example personal computers, servers, programmable logic controllers (PLCs), handheld computer systems, pocket PC devices, IoT devices, mobile radios and other communication devices that can process data in computer-aided fashion, processors and other electronic devices for data processing.

Within the context of embodiments of the invention, “computer-aided” can be understood to mean for example an implementation of the method in which in particular a processor carries out at least one method step of the method.

Within the context of embodiments of the invention, a processor can be understood to mean for example a machine or an electronic circuit. A processor can be in particular a central processing unit (CPU), a microprocessor or a microcontroller, for example an application-specific integrated circuit or a digital signal processor, possibly in combination with a memory unit for storing program instructions, etc. A processor can, by way of example, also be an IC (integrated circuit), in particular an FPGA (field programmable gate array) or an ASIC (application-specific integrated circuit), or a DSP (digital signal processor) or a graphics processor GPU (graphics processing unit). A processor can also be understood to mean a virtualized processor, a virtual machine or a soft CPU. It can, by way of example, also be a programmable processor that is equipped with configuration steps for carrying out the method according to embodiments of the invention or that is configured by configuration steps such that the programmable processor realizes the features according to embodiments of the invention for the method, the component, the modules or other aspects and/or subaspects of embodiments of the invention.

Within the context of embodiments of the invention, a “memory unit” or a “memory module” and the like can be understood to mean for example a volatile memory in the form of random access memory (RAM) or a permanent memory such as a hard disk or a data carrier.

Within the context of embodiments of the invention, a “module” can be understood to mean for example a processor and/or a memory unit for storing program instructions. By way of example, the processor is configured specifically to execute the program instructions such that the processor performs functions to implement or perform the method according to embodiments of the invention or a step of the method according to embodiments of the invention. A module can, by way of example, also be a node of the distributed database system and/or of a network application that for example performs/realizes the specific functions/features of an applicable module. The respective modules can, by way of example, also be in the form of separate or standalone modules. To this end, the applicable modules can comprise further elements, for example. These elements are for example one or more interfaces (e.g., database interfaces, communication interfaces—e.g., network interface, WLAN interface) and/or an evaluation unit (e.g., a processor) and/or a memory unit. The interfaces can be used for example to interchange (e.g., receive, convey, send or provide) data. The evaluation unit can be used for example to compare, check, process, assign or calculate data in computer-aided and/or automated fashion. The memory unit can be used for example to store, retrieve or provide data in computer-aided and/or automated fashion.

Within the context of embodiments of the invention, “comprise”, in particular in regard to data and/or information, can be understood to mean for example (computer-aided) storage of applicable information or of an applicable datum in a data structure/data record (which e.g., is in turn stored in a memory unit).

Within the context of embodiments of the invention, “assign”, in particular in regard to data and/or information, can be understood to mean for example computer-aided assignment of data and/or information. By way of example, a second datum is assigned to a first datum in this regard by a memory address or a unique identifier (UID), e.g., by storing the first datum together with the memory address or the unique identifier of the second datum together in a data record.

Within the context of embodiments of the invention, “provide”, in particular in regard to data and/or information, can be understood to mean for example computer-aided providing. Providing is effected for example via an interface (e.g., a database interface, a network interface, an interface to a memory unit). This interface can be used for example to convey and/or send and/or retrieve and/or receive applicable data and/or information during the provision.

Within the context of embodiments of the invention, “provide” can also be understood to mean for example loading or storing, for example of a transaction containing applicable data. This can, by way of example, be effected on or by a memory module. “Providing” can also be understood to mean for example transmitting (or sending or conveying) of applicable data from one node to another node of the blockchain or of the distributed database system (or the infrastructure thereof) or of the network application.

Within the context of embodiments of the invention, a “checksum”, for example a data block checksum, a data checksum, a node checksum, a transaction checksum, a concatenation checksum or the like, can be understood to mean for example a cryptographic checksum or cryptographic hash or hash value, which are formed or calculated, in particular by a cryptographic hash function, for a data record and/or data and/or one or more of the transactions and/or a subregion of a data block (e.g., the block header of a block of a blockchain or data block header of a data block of the distributed database system (or of the network application) or only some of the transactions of a data block). A checksum can be in particular a checksum/s or hash value/s of a hash tree (e.g., Merkle tree, Patricia tree). Furthermore, it can, in particular, also be understood to mean a digital signature or a cryptographic message authentication code. The checksums can, by way of example, be used to provide cryptographic protection/protection against manipulation for the transactions and the data (records) stored therein on different levels of the database system. If for example a high level of security is called for, the checksums are produced and checked at transaction level, for example. If a lower level of security is called for, the checksums are produced and checked at block level (e.g., for the entire data block or for only some of the data block and/or some of the transactions), for example.

Within the context of embodiments of the invention, a “data block checksum” can be understood to mean a checksum that for example is calculated for some or all transactions of a data block. A node can then, by way of example, check/discover the integrity/authenticity of the applicable part of a data block by the data block checksum. Additionally or alternatively, the data block checksum may in particular also have been formed for transactions of a preceding data block/predecessor data block of the data block. This data block checksum can in particular also be realized by a hash tree, for example a Merkle tree [1] or a Patricia tree, wherein the data block checksum is in particular the root checksum of the Merkle tree or of a Patricia tree or of a binary hash tree. In particular, transactions are safeguarded by further checksums from the Merkle tree or Patricia tree (e.g., by using the transaction checksums), wherein in particular the further checksums are leaves in the Merkle tree or Patricia tree. The data block checksum can thus for example safeguard the transactions by virtue of the root checksum being formed from the further checksums. The data block checksum can, in particular, be calculated for transactions of a specific data block of the data blocks. In particular, such a data block checksum can be adopted in a succeeding data block of the specific data block in order to concatenate this succeeding data block with its preceding data blocks, for example, and in particular thus to make an integrity of the distributed database system (or of the network application) checkable. This allows the data block checksum for example to undertake the function of the concatenation checksum or to be adopted in the concatenation checksum. The header of a data block (e.g., of a new data block or of the data block for which the data block checksum has been formed) can comprise the data block checksum, for example.

Within the context of embodiments of the invention, a “transaction checksum” can be understood to mean a checksum that is in particular formed for a transaction of a data block. Additionally, for example a calculation of a data block checksum for an applicable data block can be speeded up, since for example already calculated transaction checksums can immediately be used as leaves e.g., of a Merkle tree for this purpose.

Within the context of embodiments of the invention, a “concatenation checksum” can be understood to mean a checksum that, in particular, indicates or references the preceding data block of the distributed database system (or of the network application) for a respective data block of the distributed database system (or of the network application) (in particular frequently referred to as “previous block hash” in specialist literature) [1]. This in particular involves an applicable concatenation checksum being formed for the applicable preceding data block. The concatenation checksum used can be for example a transaction checksum or the data block checksum of a data block (that is to say an existing data block of the distributed database system or of the network application), in order to concatenate a new data block with an (existing) data block of the distributed database system (or of the network application). It is, by way of example, alternatively possible for a checksum to be formed for a header of the preceding data block or for all of the preceding data block and used as concatenation checksum. This can, by way of example, also be calculated for multiple or all preceding data blocks. It is, by way of example, also feasible for the concatenation checksum to be formed for the header of a data block and the data block checksum. However, a respective data block of the distributed database system (or of the network application) comprises a respective concatenation checksum that was calculated for or relates to a preceding data block, in particular even more the directly preceding data block, of the respective data block. It is, by way of example, also possible for an applicable concatenation checksum to be also formed only for a portion of the applicable data block (e.g., preceding data block). This allows for example a data block to be produced that comprises an integrity-protected portion and an unprotected portion. This would allow for example a data block to be produced whose integrity-protected portion is invariable and whose unprotected portion can also still be altered later (e.g., in order to also store personal data in the unprotected portion). Integrity-protected is intended to be understood here to mean in particular that an alteration of integrity-protected data is discoverable by a checksum.

The data stored in a transaction of a data block, for example, can, in particular, be provided in different ways. Instead of the data, e.g., user data such as measurement data or data/ownership relationships pertaining to assets, a transaction of a data block can comprise only the checksum for these data, for example. The applicable checksum can be produced in various ways. This can be e.g., an applicable data block checksum of a data block (containing the applicable data) of another database or of the distributed database system (or of the network application), a transaction checksum of a data block containing the applicable data (of the distributed database system/the network application or of another database) or a data checksum that was formed for the data.

Additionally, the applicable transaction can also comprise a reference to or an indication of a memory location (e.g., an address of a file server and details as to where the applicable data can be found on the file server; or an address of another distributed database/network application that comprises the data). The applicable data could then, by way of example, also be provided in another transaction of a further data block of the distributed database system/the network application (e.g., if the applicable data and the associated checksums are contained in different data blocks). It is, by way of example, alternatively conceivable for these data to be provided via another communication channel (e.g., via another database and/or a cryptographically secured communication channel).

It is also possible, by way of example, for, in addition to the checksum, an additional data record (e.g., a reference to or an indication of a memory location) to be stored in the applicable transactions, in particular indicating a memory location from which the data can be retrieved. This is in particular advantageous for keeping a data size of the blockchain or of the distributed database system/the network application as small as possible.

Within the context of embodiments of the invention, “security-protected” can be understood to mean for example protection provided in particular by a cryptographic method. By way of example, this can be brought about by using the distributed database system (or the network application) to provide or transmit or send applicable data/transactions. This is achieved by combining the various (cryptographic) checksums, since these interact in particular in synergistic fashion in order for example to improve the security or cryptographic security for the data of the transactions. In other words, “security-protected” within the context of embodiments of the invention can in particular also be understood to mean “cryptographically protected” and/or “protected against manipulation”, “protected against manipulation” also being able to be referred to as “integrity-protected”.

Within the context of embodiments of the invention, “concatenation of (the) data blocks of a distributed database system/a network application” can be understood to mean for example that data blocks each comprise information (e.g., concatenation checksum) referring to or referencing another data block or multiple other data blocks of the distributed database system (or of the network application) [1][4][5].

Within the context of embodiments of the invention, “insertion into the distributed database system/the network application” and the like can be understood to mean for example that, in particular, a transaction or the transactions or a data block with its transactions is conveyed to one or more nodes of a distributed database system/a network application. If these transactions are for example validated successfully (e.g., by the node/s), these transactions are in particular concatenated as a new data block with at least one existing data block of the distributed database system/the network application [1][4][5]. For this purpose, the applicable transactions are stored for example in a new data block. In particular, this validation and/or concatenation can be performed by a trusted node (e.g., a mining node, a blockchain oracle or a blockchain platform). In particular, a blockchain platform can be understood to mean a blockchain as a service, as proposed in particular by Microsoft or IBM. In particular, a trusted node and/or a node can each store a node checksum (e.g., a digital signature) in a data block (e.g., in the data block validated and produced thereby, which is then concatenated), in order in particular to make it possible to identify the originator of the data block and/or to make it possible to identify the node. In this case, this node checksum indicates which node has for example concatenated the applicable data block with at least one other data block of the distributed database system (or of the network application).

Within the context of embodiments of the invention, “transaction” or “transactions” can be understood to mean for example a smart contract [4][5], a data structure or a transaction data record that, in particular, each comprise one of the transactions or multiple transactions. Within the context of embodiments of the invention, “transaction” or “transactions” can also be understood to mean for example the data of a transaction of a data block of a blockchain. A transaction can in particular comprise a program code that provides a smart contract, for example. By way of example, within the context of embodiments of the invention, a transaction can also be understood to mean a control transaction and/or confirmation transaction. Alternatively, a transaction can be for example a data structure that stores data (e.g., a smart contract and/or the control instructions and/or contractual data and/or other data such as video data, user data, measurement data, etc.).

In particular, “storage of transactions in data blocks”, “storage of transactions” and the like is supposed to be understood to mean direct storage or indirect storage. Direct storage can be understood to mean for example that the applicable data block (of the distributed database system/the network application) or the applicable transaction (of the distributed database system/the network application) comprises the respective data. Indirect storage can be understood to mean for example that the applicable data block or the applicable transaction comprises a checksum and optionally an additional data record (e.g., a reference or indication to a memory location) for applicable data, and the applicable data are therefore not stored in the data block (or the transaction) directly (that is to say only a checksum for these data instead). In particular, the storage of transactions in data blocks can result in these checksums being validated, for example, as explained under “insertion into the distributed database system/the network application”, for example.

Within the context of embodiments of the invention, a “program code” (e.g., a smart contract or chain code) can be understood to mean for example a program instruction or multiple program instructions, in particular stored in one or more transactions. The program code is in particular executable and is executed by the distributed database system/the network application, for example. This can be realized by an execution environment (e.g., of a virtual machine), for example, the execution environment or the program code being Turing complete. The program code is executed by the infrastructure of the distributed database system/the network application [4][5]. This involves for example a virtual machine being realized by the infrastructure of the distributed database system (or of the network application).

Within the context of embodiments of the invention, a “smart contract” can be understood to mean for example an executable program code [4][5] (see in particular the “program code” definition). The smart contract is stored in a transaction of a distributed database system/the network application (e.g., a blockchain), for example in a data block of the distributed database system (or of the network application). By way of example, the smart contract can be executed in the same way as explained in the definition of “program code”, in particular within the context of embodiments of the invention.

Within the context of embodiments of the invention, “smart contract process” can be understood to mean in particular execution of a program code (e.g., of the control instructions) in a process by the distributed database system/the network application, wherein for example the applicable infrastructure of the distributed database system/the network application executes the program code.

Within the context of embodiments of the invention, “proof-of-work evidence” can be understood to mean for example solving a computationally intensive problem that, in particular, needs to be solved on the basis of the data block content/content of a specific transaction [1][4][5]. A computationally intensive problem of this kind is, by way of example, also referred to as a cryptographic puzzle.

Within the context of embodiments of the invention, a “network application” can be understood to mean for example a locally distributed database, a distributed database system, a distributed database, a peer-to-peer application, a distributed memory management system, a blockchain, a distributed ledger, a distributed memory system, a distributed ledger technology (DLT) based system (DLTS), a revision-proof database system, a cloud, a cloud service, a blockchain in a cloud or a peer-to-peer database. It is also possible, by way of example, for different implementations of a blockchain or DLTS to be used, such as e.g., a blockchain or DLTS that is implemented by a directed acyclic graph (DAG), a cryptographic puzzle, a hash graph or a combination of the implementation variants [6][7]. It is also possible, by way of example, for different consensus methods (consensus algorithms) to be implemented. These can be for example a consensus method by a cryptographic puzzle, gossip about gossip, virtual voting or a combination of the methods (e.g., gossip about gossip in combination with virtual voting) [6][7]. If a blockchain is used, for example, then it can be implemented in particular by a Bitcoin-based implementation or an Ethereum-based implementation [1][4][5]. A “distributed database system” or a “network application” can also be understood to mean for example a distributed database system or a network application that has at least some of its nodes and/or devices and/or infrastructure realized by a cloud. By way of example, the applicable components are implemented as nodes/devices in the cloud (e.g., as virtual nodes in a virtual machine). This can be accomplished by VM-ware, Amazon Web Services or Microsoft Azure, for example. On account of the high flexibility of the implementation variants explained, it is, in particular, also possible for subaspects of the implementation variants to be combined with one another, e.g., by using a hash graph as a blockchain, the blockchain itself e.g., also being able to be blockless.

If for example a directed acyclic graph (DAG) is used (e.g., IOTA or Tangle), then in particular transactions or blocks or nodes of the graph are connected to one another via directed edges. Acyclic in this instance means in particular that there are no directed loops in the graph.

The distributed database system/the network application can be a public distributed database system/a public network application (e.g., a public blockchain) or a closed (or private) distributed database system/a closed network application (e.g., a private blockchain), for example.

If it is a public distributed database system/a public network application, for example, this means that new nodes and/or devices are able to join or be accepted by the distributed database system/the network application without proof of authorization or without authentication or without registration information or without credentials. In particular, the operators of the nodes and/or devices can remain anonymous in such a case.

If the distributed database system/the network application is a closed distributed database system, for example, then new nodes and/or devices require valid proof of authorization and/or valid authentication information and/or valid credentials and/or valid registration information, for example, in order to be able to join or be accepted by the distributed database system/the network application.

A distributed database system/the network application can also be a distributed communication system for data interchange, for example. This can be a network or a peer-to-peer network, for example.

A/the distributed database system can also be a local distributed database system and/or a local distributed communication system, for example.

A “network application” can also be a network application infrastructure, for example, or the network application comprises a corresponding network application infrastructure. This infrastructure can comprise nodes and/or communication networks and/or data interface and/or further components, for example, in order to implement or execute the network application. The network application can be e.g., a distributed network application (e.g., a distributed peer-to-peer application or a distributed database system) that is executed on multiple nodes of the network application infrastructure, for example.

Within the context of embodiments of the invention, “data block”, which, in particular depending on context and implementation, can also be referred to as “link” or “block”, can be understood to mean for example a data block of a distributed database system/a network application (e.g., a blockchain or a peer-to-peer database) that is, in particular, implemented as a data structure and in each case comprises one of the transactions or several of the transactions. In one implementation, the database (or the database system) can be a DLT based system (DLTS) or a blockchain and a data block can be a block of the blockchain or of the DLTS, for example. A data block can comprise details pertaining to the size (data size in bytes) of the data block, a data block header (block header), a transaction counter and one or more transactions, for example [1]. The data block header can comprise a version, a concatenation checksum, a data block checksum, a timestamp, proof-of-work evidence and a nonce (one-time value, random value or counter used for the proof-of-work evidence), for example [1][4][5]. A data block can, by way of example, also be just a specific memory area or address area for the total data stored in the distributed database system/the network application. It is thus possible, by way of example, for blockless distributed database systems/network applications, such as e.g., the IoT chain (ITC), IOTA and Byteball, to be implemented. These involve in particular the functionalities of the blocks of a blockchain and of the transactions being combined with one another such that e.g., the transactions themselves protect the sequence or chain of transactions (of the distributed database system/the network application) (that is to say store them in security-protected fashion, in particular). To this end, for example a concatenation checksum can be used to concatenate the transactions themselves with one another by virtue of a separate checksum or the transaction checksum of one or more transactions being used as concatenation checksum, which is stored in the applicable new transaction as well when a new transaction is stored in the distributed database system/the network application. In such an embodiment, a data block can also comprise one or more transactions, for example, one data block corresponding to one transaction in the simplest case, for example. By way of example, in addition to a checksum for the transactions, it is also possible to insert a checksum for the “state”, i.e. the states of the smart contracts and/or of the nodes, and/or for the return values of the transactions (transaction receipts) e.g., into the transaction and/or the data block.

Within the context of embodiments of the invention, “nonce” can be understood to mean for example a cryptographic nonce (abbreviation for “used only once” [2] or “number used once” [3]). In particular, a nonce denotes individual combinations of numbers or a combination of letters that is used just once in the respective context (e.g., transaction, data transmission).

Within the context of embodiments of the invention, “preceding data blocks of a (specific) data block of the distributed database system/the network application” can be understood to mean for example the data block of the distributed database system/the network application that in particular directly precedes a (specific) data block. Alternatively, “preceding data blocks of a (specific) data block of the distributed database system/the network application” can, in particular, also be understood to mean all data blocks of the distributed database system/the network application that precede the specific data block. As a result, the concatenation checksum or the transaction checksum can, in particular, be formed only for the data block (or the transactions thereof) directly preceding the specific data block or for all data blocks (or the transactions thereof) preceding the first data block, for example.

Within the context of embodiments of the invention, a “blockchain node”, “node”, “node of a distributed database system/the network application” and the like can be understood to mean for example devices (e.g., field devices, mobile phones), computers, smartphones, clients or subscribers that perform operations for (with) the distributed database system/the network application (e.g., a blockchain) [1][4][5]. Such nodes can, by way of example, execute transactions of a distributed database system/a network application or the data blocks thereof or insert or concatenate new data blocks with new transactions into the distributed database system/the network application by new data blocks. In particular, this validation and/or concatenation can be performed by a trusted node (e.g., a mining node) or solely by trusted nodes. A trusted node is, by way of example, a node that has additional security measures (e.g., firewalls, access restrictions to the node or the like) in order to prevent manipulation of the node. Alternatively or additionally, a trusted node can store a node checksum (e.g., a digital signature or a certificate) in a new data block when the new data block is concatenated with the distributed database system/the network application, for example. Both node checksums can be for example a checksum, e.g., for a data block or a transaction, signed by an applicable node. It is thus, in particular, possible to provide proof indicating that the applicable data block was inserted by a specific node or indicating its origin. The devices (e.g., the applicable device) are for example devices of a technical system and/or industrial installation and/or of an automation network and/or of a manufacturing installation that are in particular also a node of the distributed database system/the network application. The devices in this instance can be for example field devices or devices in the Internet of Things that are in particular also a node of the distributed database system/the network application. Nodes can, by way of example, also comprise at least one processor, e.g., in order to perform their computer-implemented functionality.

Within the context of embodiments of the invention, a “blockchain oracle” and the like can be understood to mean for example nodes, devices or computers that e.g., have a security module that comprises for example software protection mechanisms (e.g., cryptographic methods), mechanical protection devices (e.g., a lockable housing) or electrical protection devices (e.g., tamperproofing or a protection system that erases the data of the security module in the event of inadmissible use/handling of the blockchain oracle). The security module can comprise cryptographic keys, for example, which are necessary e.g., for signing the transaction and/or for calculating the checksums (e.g., transaction checksums or node checksums).

Within the context of embodiments of the invention, a “computer” or a “device” can be understood to mean for example a computer (system), a client, a smartphone or a server that are in each case arranged outside the blockchain or are not subscribers of the distributed database system/the network application (e.g., the blockchain) (that is to say do not perform operations with the distributed database system/the network application, or only query them, without, however, performing transactions, inserting data blocks or calculating proof-of-work evidence). Alternatively, a computer can, in particular, also be understood to mean a node of the distributed database system/the network application. In other words, a device can, in particular, be understood to mean a node of the distributed database system/the network application or perhaps a device outside the blockchain or the distributed database system/the network application. A device outside the distributed database system/the network application can access the data (e.g., transactions or control transactions) of the distributed database system/the network application and/or be actuated by nodes (e.g., by smart contracts and/or blockchain oracles), for example. If for example actuation or control of a device (e.g., a device in the form of a node or a device outside the distributed database system/the network application) is performed by a node, this can be accomplished e.g., by a smart contract that is, in particular, stored in a transaction of the distributed database system/the network application. A computer or a device can, by way of example, also be part of the infrastructure that e.g., executes, implements or comprises the network application or the distributed database system.

Embodiments of the invention advantageous for allowing reliable execution of the transactions, which can also be referred to as useful transactions, for example, at the correct time. In particular, the presupposition transaction can predefine times for the execution of the useful transactions by the execution control transaction, e.g., as a result of these times being stored in the presupposition transaction, the presupposition transaction being assigned e.g., to a specific transaction or to the useful transaction. This allows many kinds of conventional contracts to be mapped to smart contracts, for example. This is e.g., particularly advantageous if the control system, which e.g., is implemented as a network application, is used to realize a digital twin for a device (e.g., a manufacturing device, a gas turbine or a field device). In this case, e.g., the memory module and optionally the assigning module can e.g., use a network application or a database to realize the digital twin. In particular, the applicable useful transactions that are supposed to be executed can comprise control instructions that are used e.g., to monitor and/or control the device.

In a first embodiment of the control system, a data block of the control system comprises transactions that meet the applicable requirements.

In further embodiments of the control system, the presupposition transaction and/or the execution control transaction is/are used to control periodic execution of the transaction and/or of a further transaction (e.g., likewise periodically) between two times.

In further embodiments of the control system, the presupposition transaction and/or the execution control transaction is/are used to control periodic execution of the transaction and/or of a further transaction with a predefined period from a predefined time onward.

In further embodiments of the control system, the presupposition transaction and/or the execution control transaction and/or the transaction predefine a further transaction for execution.

In further embodiments of the control system, the presupposition transaction and/or the execution control transaction and/or the transaction predefine a predefined execution time for the execution of the further transaction.

In further embodiments of the control system, the execution time for a further transaction is after an execution of the transaction.

This is advantageous e.g., for executing the further transaction after the time after which the execution of the transaction has concluded. This execution of the further transaction can e.g., additionally be dependent on a successful or unsuccessful execution of the transaction. By way of example, it is also conceivable for a successful execution of the transaction to result in a first further transaction being executed and for example an unsuccessful execution to result in a second further transaction being executed. It is therefore possible to react flexibly to the result of an execution of the transaction, for example.

In further embodiments of the control system, the presupposition transaction and/or the execution control transaction and/or the transaction are stored in a data block or multiple data blocks. Alternatively or additionally, the control system is for example a distributed database system. Alternatively or additionally, the distributed database system is a blockchain. Alternatively or additionally, the presupposition transaction and/or the execution control transaction and/or the transaction are each transactions e.g., of a/the blockchain. Alternatively or additionally, the presupposition transaction and/or the execution control transaction and/or the transaction are smart contracts.

In further embodiments of the control system, the presuppositions predefine an execution time for the transaction.

According to a further aspect, embodiments of the invention relates to a computer-implemented method having the following method steps:
storing at least one transaction and/or at least one execution control transaction and/or at least one presupposition transaction in a memory module;
assigning the execution control transaction and/or the presupposition transaction to the transaction, wherein the execution control transaction controls an execution of the transaction by the control system when presuppositions of the presupposition transaction are complied with.

In further embodiments of the method, the method comprises further method steps for realizing the functional features of the control system.

In addition, a computer program product (non-transitory computer readable storage medium having instructions, which when executed by a processor, perform actions)having program instructions for performing the cited methods according to embodiments of the invention is claimed, wherein the computer program product can be used to perform one of the methods according to embodiments of the invention, all the methods according to the invention or a combination of the methods according to embodiments of the invention in each case.

Additionally, a variant of the computer program product having program instructions for configuring a creating device, for example a 3D printer, a computer system or a production machine suitable for creating processors and/or devices is claimed, wherein the creating device is configured by the program instructions in such a way that the specified control system according to embodiments of the invention is created.

Furthermore, a providing apparatus for storing and/or providing the computer program product is claimed. The providing apparatus is for example a data medium that stores and/or provides the computer program product. Alternatively and/or additionally, the providing apparatus is for example a network service, a computer system, a server system, in particular a distributed computer system, a cloud-based computer system and/or virtual computer system that stores and/or provides the computer program product in the form of a data stream.

This provision is effected for example as a download in the form of a program data block and/or instruction data block, as a file, in particular as a download file, or as a data stream, in particular as a download data stream, of the complete computer program product. However, this provision can for example also be implemented as a partial download that consists of multiple parts and, in particular, is downloaded via a peer-to-peer network or provided as a data stream. By way of example, such a computer program product is read into a system by using the providing apparatus in the form of the data medium and executes the program instructions, as a result of which the method according to embodiments of the invention is executed on a computer or configures the creating device in such a way that it creates the control system according to embodiments of the invention.

### BRIEF DESCRIPTION

Some of the embodiments will be described in detail, with references to the following Figures, wherein like designations denote like members, wherein:

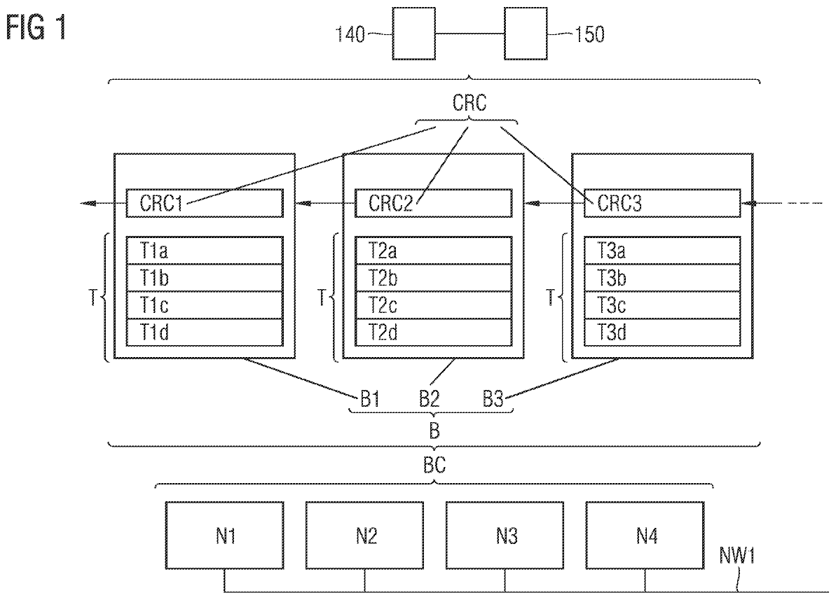

FIG. 1 shows a first exemplary embodiment of the invention;

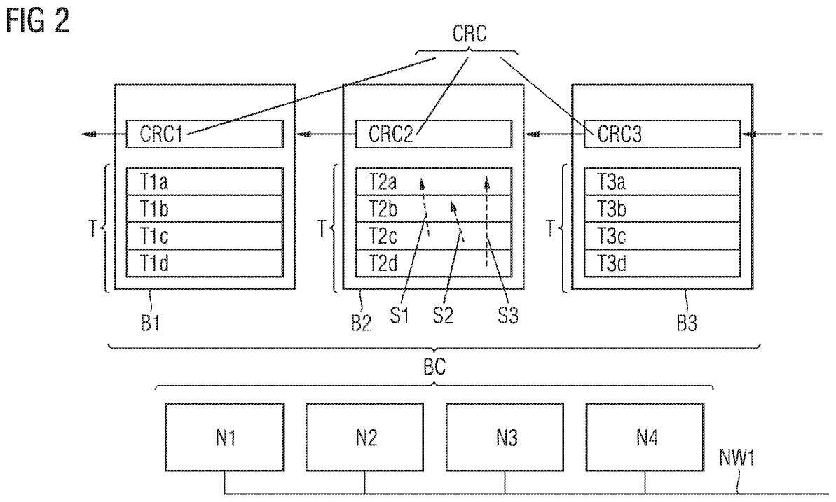

FIG. 2 shows a further exemplary embodiment of the invention; and

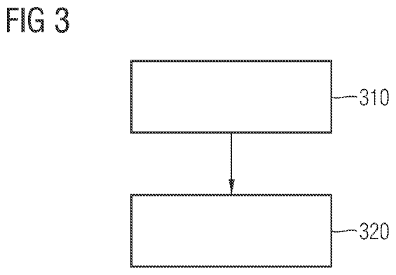

FIG. 3 shows a further exemplary embodiment of the invention.

### DETAILED DESCRIPTION

Unless indicated otherwise or indicated already, the exemplary embodiments that follow have at least one processor and/or a memory unit in order to implement or carry out the method.

In particular, a person skilled in the (relevant) art who is aware of the method claim/method claims naturally also knows of all possibilities for producing products or possibilities for implementation that are customary in the conventional art, which means that there is in particular no need for a separate disclosure in the description. In particular, these conventional realization variants known to a person skilled in the art can be realized exclusively by way of hardware (components) or exclusively by way of software (components). Alternatively and/or additionally, a person skilled in the art is able, within the scope of his ability in the art, to choose largely arbitrary combinations, according to embodiments of the invention, of hardware (components) and software (components) in order to implement realization variants according to embodiments of the invention.

A combination of hardware (components) and software (components) that is in accordance with embodiments of the invention can arise in particular if some of the effects according to embodiments of the invention are brought about exclusively by specialist hardware (e.g., a processor in the form of an ASIC or FPGA) and/or others are brought about by the (processor- and/or memory-assisted) software.

In particular, in view of the great number of different realization options, it is neither possible nor productive or necessary for the understanding of embodiments of the invention to specify all of these realization options. In this respect, all the exemplary embodiments that follow should, in particular, merely by way of illustration, highlight a few ways in which, in particular, such realizations of the teaching according to embodiments of the invention could appear.

Consequently, the features of the individual exemplary embodiments are in particular not restricted to the respective exemplary embodiment but rather, in particular, relate to embodiments of the invention in general. Accordingly, features of one exemplary embodiment may also serve as features for another exemplary embodiment, in particular without this having to be explicitly mentioned in the respective exemplary embodiment.

FIG. 1 shows a control system that is used to control the execution of transactions, for example. This control can be for example control of the devices of an energy distribution grid, control of the manufacturing devices of a manufacturing installation or control of the devices of a power station.

The control system shown in FIG. 1 can be for example a network application in the form of a blockchain or a distributed database system realized by a blockchain.

The control system has a memory module 140 and an assigning module 150. The memory module 140 is configured to store at least one transaction and/or at least one execution control transaction and/or at least one presupposition transaction. The memory module 140 can also comprise further transactions of the distributed database system or of the blockchain. In variants of embodiments of the invention, the memory module 140 is the network application or the distributed database system implemented e.g., as a blockchain. In variants of embodiments of the invention, the memory module 140 is realized by the network application or by the distributed database system.

The assigning module 150 is configured to assign the execution control transaction and/or the presupposition transaction to the transaction, wherein the execution control transaction controls an execution of the transaction by the control system when presuppositions of the presupposition transaction are complied with.

In order to control devices, the transaction can comprise control instructions, for example, which are executed with the transaction e.g., in order to control a device.

FIG. 1 shows a first node N1, a second node N2, a third node N3 and a fourth node N4, which form the nodes of the blockchain BC of the distributed database system by way of illustration, one of the nodes, e.g., the first node N1, being the device that is supposed to be controlled by the transaction. The nodes are connected to one another e.g., via a first communication network NW1. The distributed database system can moreover also comprise a multiplicity of further nodes.

In addition, FIG. 1 shows blocks B, for example a first block B1, a second block B2 and a third block B3, of the blockchain BC, a detail of the blockchain BC in particular being shown by way of example here.

The blocks B each comprise multiple transactions T. By way of example, the first block B1 comprises a first transaction T1a, a second transaction T1b, a third transaction T1c and a fourth transaction T1d.

By way of example, the second block B2 comprises a fifth transaction T2a, a sixth transaction T2b, a seventh transaction T2c and an eighth transaction T2d.

By way of example, the third block B3 comprises a ninth transaction T3a, a tenth transaction T3b, an eleventh transaction T3c and a twelfth transaction T3d.

The blocks B each additionally also comprise one of the concatenation checksums CRC formed on the basis of the direct predecessor block. Therefore, the first block B1 comprises a first concatenation checksum CRC1 from its predecessor block, the second block B2 comprises a second concatenation checksum CRC2 from the first block B1, and the third block B3 comprises a third concatenation checksum CRC3 from the second block B2.

The respective concatenation checksum CRC1, CRC2, CRC3 is formed using the block header of the applicable predecessor block. The concatenation checksums CRC can be formed using a cryptographic hash function such as e.g., SHA-256, KECCAK-256 or SHA-3. By way of example, the concatenation checksum can additionally be calculated using the data block checksum, or the header comprises the data block checksum (the data block checksum is explained as a follow-up).

Additionally, each of the blocks can comprise a data block checksum. This can be realized by a hash tree, for example.

In order to form the hash tree, a transaction checksum (e.g., likewise a hash value) is calculated for each transaction of a data (block). Alternatively or additionally, a transaction checksum that was created by the producer of the transaction when producing the transaction can continue to be used for this purpose.

Normally, e.g., a Merkle tree or Patricia tree, the root hash value/root checksum of which is stored in the respective blocks as a corresponding data block checksum, is used for a hash tree.

In one variant, the data block checksum is used as concatenation checksum.

A block can furthermore have a timestamp, a digital signature or proof-of-work evidence, as was explained in the embodiments of the invention.

The blockchain BC itself is realized by a blockchain infrastructure having multiple blockchain nodes (nodes N1, N2, N3, N4 and further blocks). The nodes can be blockchain oracles or trusted nodes, for example.

The nodes are communicatively connected to one another via the network NW1 (e.g., a communication network such as the Internet or an Ethernet network). The blockchain infrastructure is used for example to replicate at least some of the data blocks B or all of the data blocks B of the blockchain BC for some or all of the nodes of the blockchain.

The memory module 140 and/or the assigning module 150 can be realized e.g., by components or parts of the blockchain (or the network application or the distributed database system) that have been configured and/or built specifically for this purpose. By way of example, the memory module 140 and/or the assigning module 150 can each be realized by one or more nodes that have been configured specifically for the function. These nodes can be processors e.g., in the form of ASICs, for example. In an embodiment, the memory module 140 and/or the assigning module 150 are realized by multiple nodes in a similar form, e.g., in order to maintain the functionality of the memory module 140 and/or of the assigning module 150 and to ensure operation of the control system in the event of failure of one node.

FIG. 2 presents a possible implementation by the distributed database system (e.g., a blockchain) or the network application in more detail. The transaction T2a is e.g., the transaction that is supposed to be carried out. The transaction T2b is e.g., the presupposition transaction and the transaction T2c is for example the execution control transaction.

The execution control transaction and/or the presupposition transaction can be assigned for example by virtue of the applicable transactions being linked to the execution control transaction, these link data being stored in a link transaction, for example (S3). The link transaction can e.g., be the transaction T2d (or another transaction such as the transaction T3a). The link can be made for example by virtue of applicable link data being stored in the link transaction. The link data can be for example hash values, addresses or unique identifiers (e.g., a UID) for the applicable transactions, the transactions possibly comprising applicable data such as e.g., an applicable unique identifier.

The execution control transaction is for example executed as a smart contract or as a chain code by the blockchain and can load an execution time for the transaction T2a (S2) for example by way of access to the presupposition transaction (to this end the presupposition transaction is e.g., read by the execution control transaction).

The execution transaction then checks the presupposition in the form of an execution time by virtue of for example a blockchain oracle requesting the current time e.g., at intervals of 10 seconds. When the execution time has been reached, the transaction T2a is executed by the execution transaction T2c (S1).

In variants, for example, it is also possible for the presupposition transaction and/or the link transaction to be stored in the execution transaction. In this instance, the execution transaction is assigned (directly) to the transaction T2a without relatively complex data management being necessary.

Alternatively, this can e.g., also be accomplished by storing the data of the presupposition transaction and/or of the link transaction in the execution transaction.

Embodiments of the invention are used for example to solve the problem of automatic execution of smart contracts by the control system by virtue of there being, on the control system, execution transactions that prompt automatic execution of other transactions (“terminated transactions”) at one or more previously stipulated time(s). The control system comprises a distributed ledger, a network application or a distributed database system, for example, or the control system is a distributed ledger, a network application or a distributed database system.

The control system can have instances that check the validity of the transactions. These instances can be e.g., specific nodes or smart contracts. This can e.g., also be realized by the memory module 140 and/or the assigning module 150, or the instances are the memory module 140 and/or the assigning module 150.

The task of these instances is e.g., to store transactions (e.g., presupposition transactions) with a predefined execution time and to execute them when the time is reached. This execution takes place for example only if it is still possible according to the rules of the distributed ledger or control system. The execution is controlled by the execution transactions, for example.

The terminated transaction takes place for example only if there is sufficient credit in the sending address. This is also checked by e.g., the execution transactions, and the credit required for the execution is e.g., likewise stored in the applicable presupposition transaction.

In the case of distributed ledgers based on proof of work, the instances or nodes responsible for checking the transactions are the miners. Accordingly, the miners would be responsible for storing and executing the transactions at the given time on a distributed ledger that is based on proof of work. A new block is deemed protocol-compliant in this case only if it contains all of the executable terminated transactions.

In a further variant of the control system, the originator of the transaction, which prompts automatic execution of other transactions at one or more previously stipulated time(s), can cancel the execution of such as yet unexecuted transactions, which means that they are not executed.

In a further variant of the control system, a repeated execution of transactions at predefined times can be realized in that, as part of a transaction at one predefined time, a further transaction is prompted at another, later predefined time.

In a further variant of the control system, the presupposition transaction and/or the execution transactions are used to stipulate what differences between the execution time of the transaction and the previously stipulated time are tolerated when checking the transactions. This avoids the following problems, for example:

Problems that stem from the necessarily imperfect synchronism of various nodes of the distributed ledger and those caused by the granularity of the execution times of transactions are avoided.

The control system can for example additionally also comprise a further component or multiple further components, such as for example a processor, a memory unit, further communication interfaces (e.g., Ethernet, WLAN, USB, fieldbus, PCI), an input device, in particular a computer keyboard or a computer mouse, and a display device (e.g., a monitor). The processor can for example comprise multiple further processors, which can be used in particular for realizing further exemplary embodiments.

FIG. 3 shows a further exemplary embodiment of the invention, which is presented as a flowchart for a method.

The method is performed in computer-aided fashion.

Specifically, this exemplary embodiment shows a method for computer-aided or computer-implemented execution of transactions.

The method comprises a first method step 310 for storing at least one transaction and/or at least one execution control transaction and/or at least one presupposition transaction in a memory module.

The method comprises a second method step 320 for assigning the execution control transaction and/or the presupposition transaction to the transaction, wherein the execution control transaction controls an execution of the transaction by the control system when presuppositions of the presupposition transaction are complied with.

The control system can be used to improve the execution of smart contracts in blockchains, for example.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A control system comprising:
a memory module, wherein, the memory module is configured to store at least one transaction and/or at least one execution control transaction and/or at least one presupposition transaction;
an assigning module, wherein, the assigning module is configured to assign the at least one execution control transaction and/or the at least presupposition transaction to the at least one transaction,
wherein the execution control transaction controls an execution of the at least one transaction by the control system when presuppositions of the at least one presupposition transaction are complied with.

2. The control system as claimed in claim 1, wherein
a data block of the control system comprises transactions that meet the applicable requirements.

3. The control system as claimed in claim 1, wherein
the at least one presupposition transaction and/or the at least one execution control transaction is/are used to control periodic execution of the at least one transaction and/or of a further transaction between two times.

4. The control system as claimed in claim 1, wherein
the at least one presupposition transaction and/or the at least one execution control transaction is/are used to control periodic execution of the at least one transaction and/or of a further transaction with a predefined period from a predefined time onward.

5. The control system as claimed in claim 1, wherein
the at least one presupposition transaction and/or the at least one execution control transaction and/or the at least one transaction predefine a further transaction for execution.

6. The control system as claimed in claim 5, wherein the at least one presupposition transaction and/or the at least one execution control transaction and/or the at least one transaction predefine a predefined execution time for the execution of the further transaction.

7. The control system as claimed in claim 5, wherein the execution time is after an execution of the at least one transaction.

8. The control system as claimed in claim 1, wherein:
the at least one presupposition transaction and/or the at least one execution control transaction and/or the at least one transaction are stored in a data block or multiple data blocks, and/or
the control system is a distributed database system, and/or
the distributed database system is a blockchain, and/or
the at least one presupposition transaction and/or the at least one execution control transaction and/or the at least one transaction are each transactions of the blockchain, and/or
the at least one presupposition transaction and/or the at least one execution control transaction and/or the at least one transaction are smart contracts.

9. The control system as claimed in claim 1, wherein the presuppositions predefine an execution time for the at least one transaction.

10. A computer-implemented method comprising:
storing at least one transaction and/or at least one execution control transaction and/or at least one presupposition transaction in a memory module;
assigning the at least one execution control transaction and/or the at least one presupposition transaction to the at least one transaction, wherein the at least one execution control transaction controls an execution of the at least one transaction by the control system when presuppositions of the at least one presupposition transaction are complied with.

11. A computer program product, comprising a computer readable hardware storage device having computer readable program code stored therein, said program code executable by a processor of a computer system to implement the method as claimed in claim 10.

12. A providing apparatus for the computer program product as claimed in claim 11, wherein the providing apparatus stores and/or provides the computer program product.
